(19) United States
(12) Patent Application Publication
(10) Pub. No.: US 2009/0189900 A1
(43) Pub. Date: Jul. 30, 2009

(54) IMAGE PROCESSING APPARATUS, IMAGE PROCESSING PROGRAM, IMAGE PRODUCTION METHOD, AND RECORDING MEDIUM

(76) Inventors: Eiji Furukawa, Saitama-shi (JP); Shinichi Nakajima, Koganei-shi (JP)

Correspondence Address: OSTROLENK FABER GERB & SOFFEN, 1180 AVENUE OF THE AMERICAS, NEW YORK, NY, 100368403, US

(21) Appl. No.: 12/416,980

(22) Filed: Apr. 2, 2009

Related U.S. Application Data
(63) Continuation of application No. PCT/JP2007/068402, filed on Sep. 21, 2007.

(30) Foreign Application Priority Data
Oct. 2, 2006 (JP) 2006-271095

(51) Int. Cl. G06T 1/00

(52) U.S. Cl. 345/428

(57) ABSTRACT

An image processing apparatus includes a high-resolution processing unit configured to restore, with respect to an image desired to be displayed, a frequency band higher than a frequency band of the recorded image, using one of one electronically recorded image and a plurality of electronically recorded images obtained by continuous shooting. The image processing apparatus further includes a local region designation unit configured to designate a region of the image desired to be displayed where the resolution is increased, and an estimation display unit configured to display, as a finish estimation image after high-resolution processing is applied to the image desired to be displayed, the result of the high-resolution processing applied to a local region, designated by the local region designation unit, by the high-resolution processing unit.

### CROSS REFERENCE TO RELATED APPLICATIONS

This is a Continuation Application of PCT Application No. PCT/JP2007/068402, filed Sep. 21, 2007, which was published under PCT Article 21(2) in Japanese.

This application is based upon and claims the benefit of priority from prior Japanese Patent Application No. 2006-271095, filed Oct. 2, 2006, the entire contents of which are incorporated herein by reference.

### BACKGROUND OF THE INVENTION

1. Field of the Invention

The present invention relates to an image processing apparatus, an image processing program, an image production method, and a recording medium, in which when a resolution is increased by a super-resolution processing using a plurality of low-resolution images, the high-resolution effect in a selected local region can be easily confirmed.

2. Description of the Related Art

Japanese Patent No. 2943734 discloses a method for displaying a window attached to a mouse cursor and enlarging and displaying an image in a designated region so as not to cover and hide a range around a position designated by the mouse cursor.

Further, as a technique of generating a high quality image from a plurality of images, Japanese Patent No. 2828138 discloses a method for generating a high-resolution image, using a plurality of low-resolution images having positional deviation.

### BRIEF SUMMARY OF THE INVENTION

According to a first aspect of the present invention, there is provided an image processing apparatus comprising:
a high-resolution processing unit configured to restore, with respect to an image desired to be displayed, a frequency band higher than a frequency band of the recorded image, using one of one electronically recorded image and a plurality of electronically recorded images obtained by continuous shooting;
a local region designation unit configured to designate a region of the image desired to be displayed where the resolution is increased; and
an estimation display unit configured to display, as a finish estimation image after high-resolution processing is applied to the image desired to be displayed, the result of the high-resolution processing applied to a local region, designated by the local region designation unit, by the high-resolution processing unit.

According to a second aspect of the present invention, there is provided an image processing apparatus comprising:
a high-resolution processing unit configured to restore, with respect to an image desired to be displayed, a frequency band higher than a frequency band of the recorded image, using one of one electronically recorded image and a plurality of electronically recorded images obtained by continuous shooting;
a local region designation unit configured to designate a region of the image desired to be displayed where the resolution is increased;
a small-region selection unit configured to select a small region included in a local region designated by the local region designation unit; and
an estimation display unit configured to display, as a finish estimation image after high-resolution processing is applied to the image desired to be displayed, the result that the high-resolution processing unit applies the high-resolution processing to a small region of the image selected by the small-region selection unit.

According to a third aspect of the present invention, there is provided an image processing program making a computer execute:
restoring, with respect to an image desired to be displayed, a frequency band higher than a frequency band of the recorded image, using one of one electronically recorded image and a plurality of electronically recorded images obtained by continuous shooting;
designating a region of the image desired to be displayed where the resolution is increased; and
displaying, as a finish estimation image after high-resolution processing is applied to the image desired to be displayed, the result of the high-resolution processing applied to the designated local region of the image desired to be displayed.

According to a fourth aspect of the present invention, there is provided an image processing program making a computer execute:
restoring, with respect to an image desired to be displayed, a frequency band higher than a frequency band of the recorded image, using one of one electronically recorded image and a plurality of electronically recorded images obtained by continuous shooting;
designating a region of the image desired to be displayed where the resolution is increased;
selecting a small region included in the designated local region; and
displaying, as a finish estimation image after high-resolution processing is applied to the image desired to be displayed, the result of the high-resolution processing applied to the selected small region of the image desired to be displayed.

According to a fifth aspect of the present invention, there is provided an image production method comprising:
confirming a finish estimation image of a desired image by using the image processing apparatus according to a first aspect of the present invention; and
generating an image having a frequency band larger than a frequency band of the desired image with respect to the confirmed desired image to produce an image medium.

According to a sixth aspect of the present invention, there is provided a computer-readable recording medium recording an image including:
additional information which includes information, which indicates whether the image of a plurality of electronically recorded images, used in the estimation of a motion of a subject, is a standard image or a reference image with respect to the standard image; and
a motion estimation value which, when the image is the reference image, is estimated based on the standard image.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block configuration diagram of an electronic still camera as a first embodiment of an image processing apparatus of the invention;

FIG. 2 is a view showing a schematic appearance configuration of the electronic still camera in the first embodiment and a connection configuration between the electronic still camera and a printer;

FIG. 3 is a flowchart of a processing performed by the electronic still camera in the first embodiment and the printer connected thereto;

FIG. 4 is a view for explaining pixel mixing reading in adjacent four pixels of the same color channel;

FIG. 5 is a view showing a region of interest designation cursor displayed in a liquid crystal display panel;

FIG. 6 is a view for explaining the movement of the region of interest designation cursor and the change in the size of the region of interest designation cursor;

FIG. 7 is a view showing a display example of a high-resolution image display screen;

FIG. 8 is a view showing a display example of a region of interest discrimination display;

FIG. 9 is a view showing another display example of the high-resolution image display screen;

FIG. 10 is a view showing a display example of a control parameter setting screen;

FIG. 11 is view showing a display example of the control parameter setting screen when “number of used images” is selected;

FIG. 12 is a view showing a display example of a parameter being set;

FIG. 13 is a view showing a state in which a parameter desired to be changed is selected;

FIG. 14 is view showing a display example of the control parameter setting screen after the control parameter is changed;

FIG. 15 is a view showing a flowchart of the motion estimation processing performed by a motion estimating unit;

FIG. 16 is a view showing a similarity map for optimum similarity estimation in motion estimation;

FIG. 17A is a view showing plural continuously-photographed images;

FIG. 17B is a view showing images which are approximated to standard image by reference image deformation in which a motion estimation value is used;

FIG. 18 is a view showing a flowchart of image high-resolution processing (super-resolution processing) performed by a super-resolution processing unit;

FIG. 19 is a block diagram showing an example of a configuration of the super-resolution processing unit;

FIG. 20 is a block configuration diagram of an electronic still camera as a second embodiment of an image processing apparatus of the invention;

FIG. 21 is a flowchart of the characterized part of a processing performed by the electronic still camera in a second embodiment;

FIG. 22 is a view showing an example in which a user determines that stored motion information is reused as it is;

FIG. 23 is a view showing an example in which the user determines that the stored motion information is not reused;

FIG. 24 is a flowchart of a motion information reuse automatic determination processing of FIG. 21;

FIG. 25 is a flowchart of a motion estimation processing reusing the motion information of FIG. 21;

FIG. 26 is a view for explaining additional information added to each image in an image processing apparatus according to a third embodiment of the invention; and

FIG. 27 is a view for explaining an operation when the user wants to display an image in N+1.5 frame.

### DETAILED DESCRIPTION OF THE INVENTION

Preferred embodiments of the invention will be described below with reference to the drawings.

### First Embodiment

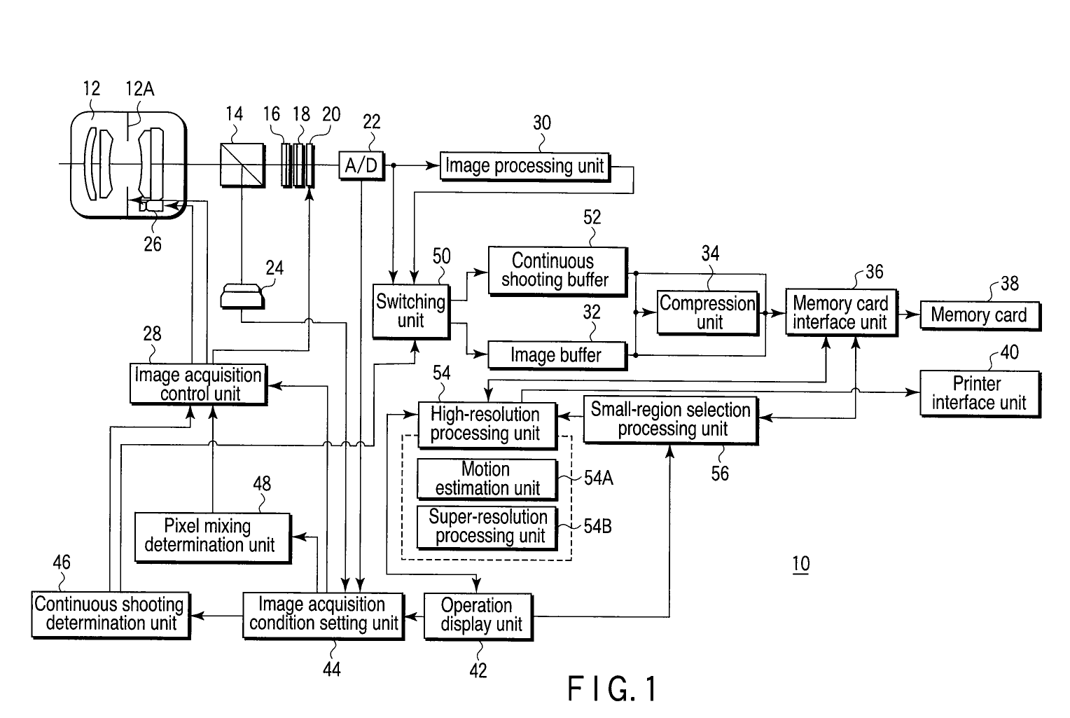

As shown in FIG. 1, an electronic still camera 10, which is a first embodiment of an image processing apparatus of the invention, includes a lens system 12 in which a diaphragm 12A is incorporated, a spectral half-mirror system 14, a shutter 16, a lowpass filter 18, a CCD imager 20, an analog-to-digital conversion circuit 22, a AE photosensor 24, an AF motor 26, an image acquisition control unit 28, an image processing unit 30, an image buffer 32, a compression unit 34, a memory card interface unit 36, a memory card 38, a printer interface unit 40, an operation display unit 42, an image acquisition condition setting unit 44, a continuous shooting determination unit 46, a pixel mixing determination unit 48, a switching unit 50, a continuous shooting buffer 52, a high-resolution processing unit 54, and a small-region selection processing unit 56.

The lens system 12 in which the diaphragm 12A is incorporated, the spectral half-mirror system 14, the shutter 16, the lowpass filter 18, and the CCD image sensor 20 are disposed along an optical axis. In the first embodiment, it is assumed that a single-plate CCD imager is used as the CCD imager 20. A light flux branched from the spectral half-mirror system 14 is guided to the AE photosensor 24. The AF motor 26 is connected to the lens system 12, and moves a part (focus lens) of the lens system 12 during focusing work.

The analog-to-digital conversion circuit 22 converts a signal from the CCD imager 20 into digital data. The digital data is fed into the image buffer 32 or the continuous shooting buffer 52 through the first image processing unit 30 and the switching unit 50. In the first embodiment, sometimes digital data is fed into image buffer 32 or the continuous shooting buffer 52 not through the first image processing unit 30 but through the switching unit 50. The switching unit 50 performs a switching operation according to an input from the continuous shooting determination unit 46.

The output from the image buffer 32 and the continuous shooting buffer 52 is input to the compression unit 34, or is input to the detachable memory card 38 through the memory card interface unit 36. The output from the compression unit 34 can also be input to the detachable memory card 38 through the memory card interface unit 36.

Signals are fed into the image acquisition condition setting unit 44 from the analog-to-digital conversion circuit 22 and the AE photosensor 24. A signal is fed from the image acquisition condition setting unit 46 into the image acquisition control unit 28, the continuous shooting determination unit 46, and the pixel mixing determination unit 48. Signals are also fed into the image acquisition control unit 28 from the continuous shooting determination unit 46 and the pixel mixing determination unit 48. The image acquisition control unit 28 controls the diaphragm 12A, the CCD imager 20, and the AF motor 26 based on the signals supplied from the image acquisition condition setting unit 44, the continuous shooting determination unit 46, and the pixel mixing determination unit 48.

The high-resolution processing unit 54 includes a motion estimation unit 54A and a super-resolution processing unit 54B and can read and write to the memory card 38 by virtue of the input and output to and from the memory card interface unit 36. Further, the high-resolution processing unit 54 can input to a printer through the printer interface unit 40. In addition, the high-resolution processing unit 54 can input and output to and from the operation display unit 42 and receives the input from the small-region selection processing unit 56. The small-region selection processing unit 56 can read and write from and to the memory card 38 by virtue of the input and output to and from the memory card interface unit 36 and can input and output to and from the operation display unit 42.

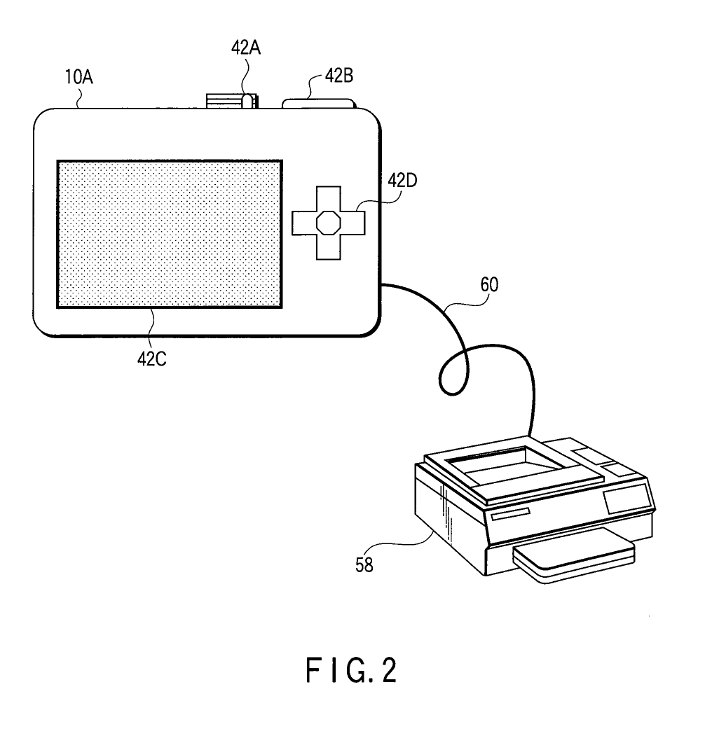

As shown in FIG. 2, the electronic still camera 10 has the operation display unit 42 including a power switch 42A and a release switch 42B, disposed on the upper surface of a camera body 10A, and a liquid crystal display panel 42C and an operation button 42D, disposed on the rear surface of the camera body 10A. The camera body 10A is connected to a printer 58 via a cable 60, connected to the printer interface unit 40 in the camera body 10A.

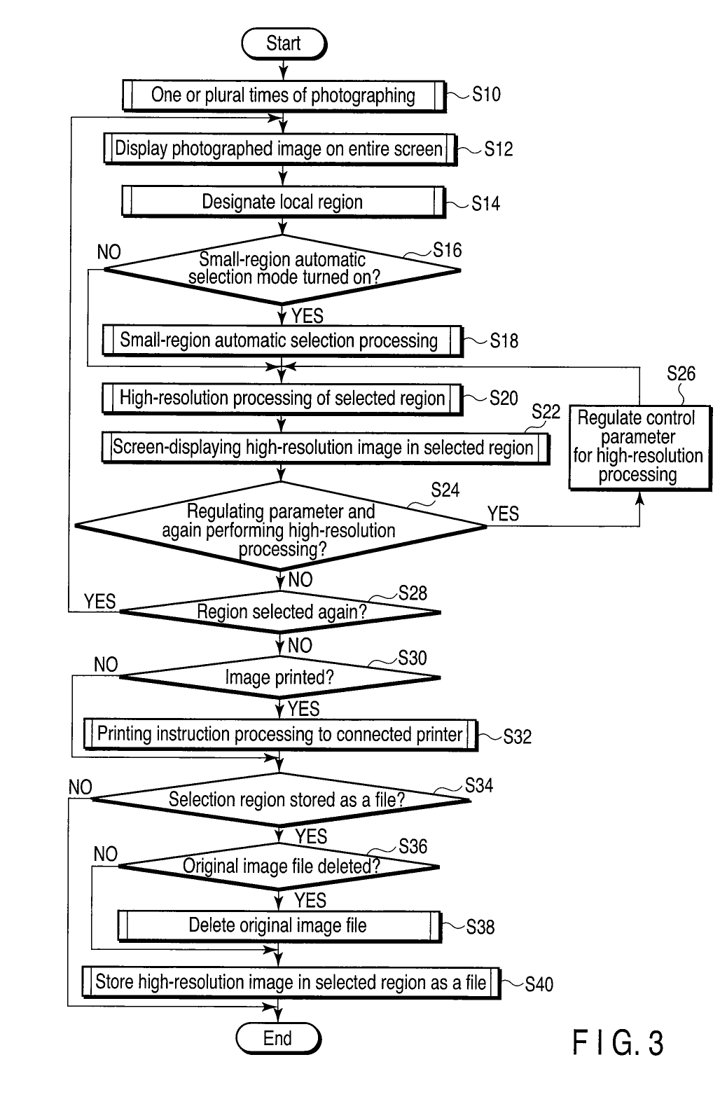

The electronic still camera 10 and the printer 58 connected thereto perform the processing shown in FIG. 3. Namely, the electronic still camera 10 first performs one or plural times of continuous shooting to thereby obtain image data required for high-resolution processing to be performed later, and, thus, to record the image data, which is an image file, in the memory card 38 (step S10). Thereafter, a user selects a photographed image to display the image on the liquid crystal display panel 42C (step S12), and, thus, to designate a local region of the image where the user wants to increase the resolution (step S14). In this case, the user operates the operation button 42D to select the local region of the image including, for example, a character or a face. The local region is selected by the small-region selection processing unit 56, and the detail will be described later. After the selection of the local region, it is determined whether or not a small-region automatic selection mode is turned on (step S16). A user operates the operation button 42D according to a setting menu displayed on the liquid crystal display panel 42C to thereby be able to set the small-region automatic selection mode.

When the small-region automatic selection mode is turned on, such a small-region automatic selection processing that a subject region is accurately reselected is performed (step S18), whereby the optimum small region is automatically selected based on the local region designated by the user in step S14. This small-region automatic selection processing is also performed by the small-region selection processing unit 56, and the detail will be described later.

The high-resolution processing unit 54 then applies the high-resolution processing to the selected region with the use of one or plural images photographed in step S10 (step S20) and displays a high-resolution image in the selected region on the screen of the liquid crystal display panel 42C (step S22). This high-resolution processing and this screen display will be described in detail later. The user confirms the screen-displayed high-resolution image in the selected region to thereby be able to determine whether the high-resolution image is printed by the printer 58 or is stored as a file in the memory card 38, and, at the same time, the user can confirm the high-resolution effect in a region of interest which is the selected region. Thereafter, when the user would again apply the high-resolution processing to the same region of interest (step S24), a control parameter is regulated again (step S26), whereby the high-resolution processing is performed using the newly regulated control parameter in step S20. The method of regulating the control parameter will be described in detail later.

When the region is selected again (step S28) without regulating the parameter (step S24), the screen-displayed high-resolution image in the selected region is deleted. Thereafter, the processing returns to step S12, and the photographed image is screen-displayed. The user again designates the local region in step S14.

Thus, when the user confirms the screen-displayed high-resolution image in the selected region to operate the operation button 42D, and, thus, to designate printing of the high-resolution image by the printer 58 (step S30), the connected printer 58 is instructed to print the high-resolution image (step S32). In this case, the high-resolution image in the selected region will be printed by the printer 58.

However, when the high-resolution processing unit 54 applies the high-resolution processing to the entire image, the entire image with high resolution can be printed. Namely, when the user confirms the high-resolution image in the selected region in step S22 and thus wants to obtain the entire image with high resolution, the region is selected again in step S28, and the entire image may be designated as the local region in step S14.

Alternatively, when the user instructs the printing of the high-resolution image in step S30, the high-resolution image in the selected region is printed, and, the high-resolution processing unit 54 automatically applies the high-resolution processing to the entire image, whereby the entire image with high resolution may be printed. Further, it may be possible to designate whether any one or both of the high-resolution image in the selected region and the entire image with high resolution is printed.

Further, the user confirms the screen-displayed high-resolution image in the selected region to operate the operation button 42D, and, thus, to be able to designate the storage of the high-resolution image as a file (step S34). At this time, an image for confirming the deletion of the original photographed image used in the high resolution processing is displayed. When the user instructs the deletion of the original taken image (step S36), the original photographed image is deleted (step S38), and the high-resolution image in the selected region is stored as a file in the memory card 38 (step S40). In this case, as in the case of the printing of the high-resolution image, the high-resolution processing unit 54 may apply the high-resolution processing to the entire image, and thus the entire image with high resolution is stored as a file, or it may be possible to designate whether any one or both of the high-resolution image in the selected region and the entire image with high resolution is stored as a file.

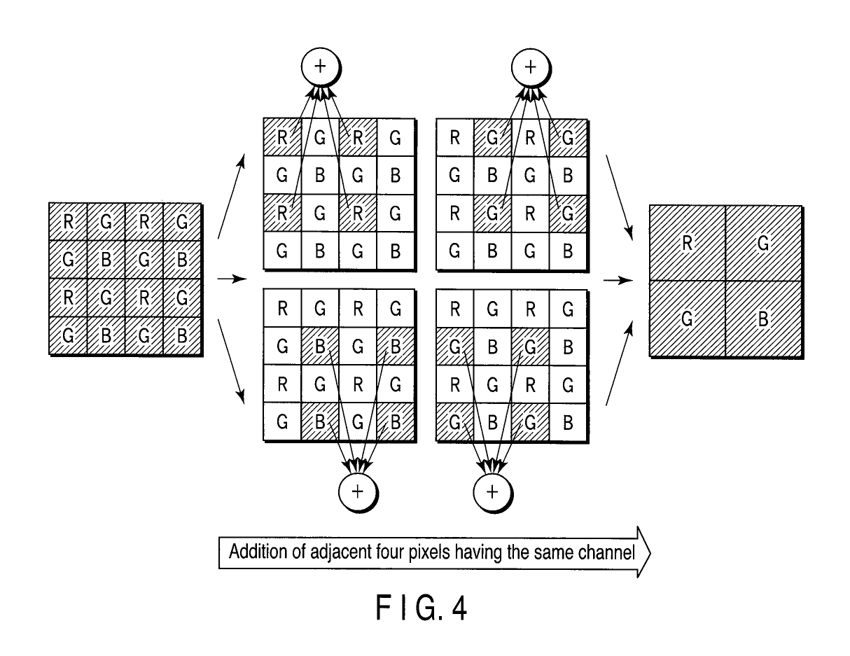

In step S10, when one or plural times of photographing is performed, in addition to usual photographing, sometimes pixel mixing read photographing is performed as the photographing method. In the pixel mixing read photographing, as shown in FIG. 4, a plurality of pixel signals of the same color channel are added (or mixed) to be read in reading the signal supplied from the CCD imager 20 in which a color filter of the Bayer array is disposed in a front face. Due to this, the resolution of an image is reduced; however, a signal of the image is read so that the sensitivity of the image is doubled or more. On the other hand, in usual photographing, the pixel mixing read is not performed, but the signal is read in each pixel in reading the signal supplied from the CCD imager 20 in which a color filter of the Bayer array is disposed in a front face.

The processing performed in the electronic still camera 10 will further be described based on a data flow.

When the user partially presses the release switch 42B, or turns on the power switch 42A, the image acquisition control unit 28 controls the diaphragm 12A, the shutter 16, and the AF motor 26 to perform pre-photographing. In the pre-photographing, the analog-to-digital conversion circuit 22 converts the signal supplied from the CCD imager 20 into a digital signal, and the first image processing unit 30 performs well- known white balance processing, highlighting processing, interpolation processing, and the like on the digital signal to supply the processed signal in the form of the image signal to equivalent to three-plate-state to the image buffer 32.

However, in the present embodiment, in the real photographing after the pre-photographing, when an image is stored without being compressed (Bayer), an image signal in a single plate state is output to the continuous shooting buffer 52 without being interpolated by the image processing unit 30. Meanwhile, when the image is compressed and stored, the image signal is interpolated by the image processing unit 30 as in the pre-photographing to be output, as the image signal to equivalent to three-plate-state, to the continuous shooting buffer 52.

In some cases, the image processing unit 30 stores the image signal in the image buffer 32 and the continuous shooting buffer 52 and thereafter applies each processing to the image signal to again store the image signal in these buffers.

In the pre-photographing, the image acquisition condition setting unit 44 fixes an image acquisition condition for the real photographing, and transfers the fixed image acquisition condition to the image acquisition control unit 28 and the continuous shooting determination unit 46. The image acquisition condition setting unit 44 fixes a photographing mode based on the image acquisition condition fixed by the continuous shooting determination unit 46, and transfers information on the fixed photographing mode to the image acquisition control unit 28 and the switching unit 50. As used herein, the image acquisition condition shall mean a set of setting values with respect to factors such as a shutter speed, an aperture scale, a focusing position, and an ISO speed which are necessary in the photographing.

The image acquisition condition setting unit 44 performs a process of fixing the image acquisition condition by a well-known technique.

The shutter speed and the aperture scale relating to an exposure amount are set based on result in which a light quantity of a subject is measured by the AE photosensor 24 through the lens system 12 and the spectral half-mirror system 14. A region which becomes a measuring target can be switched by an aperture function (not shown) disposed in front of the AE photosensor 24, and a photometric value of the region can be measured by a technique such as spot metering, center-weighted metering, and averaging metering. The combination of the shutter speed and the aperture scale can be selected by an automatic exposure scheme in which the combination of the shutter speed and the aperture scale is previously defined, a shutter speed priority scheme in which the aperture scale is obtained according to the shutter speed set by the user, or an aperture priority scheme in which the shutter speed is obtained according to the aperture scale set by the user.

The luminance data is computed from single-plate-state image data which is digital data converted from the signal supplied from the CCD imager 20 by the analog-to-digital conversion circuit 22, and the focusing position is obtained from edge intensity of the luminance data. That is, the AF motor 26 changes the focusing position of the lens system 12 in a stepwise manner, thereby estimating the focusing position where the edge intensity becomes the maximum.

The ISO speed setting method depends on the setting of a sensitivity mode of the electronic still camera 10. When the sensitivity mode of the electronic still camera 10 is set in a manual sensitivity mode, the ISO speed is set at the setting value of the user. When the sensitivity mode of the electronic still camera 10 is set in an automatic sensitivity mode, the ISO speed is fixed based on the result in which the light quantity of the subject is measured by the AE photosensor 24 through the lens system 12 and the spectral half-mirror system 14. That is, the ISO speed is set at a high value in the case of a small light quantity measured by the AE photosensor 24, and is set at a low value in the case of a large light quantity. The ISO speed in the first embodiment shall mean a value indicating a degree of electric amplification (gain up) with respect to the signal supplied from the CCD imager 20, and the degree of electric amplification is enhanced as the ISO speed is increased.

Thus, when the user completely presses the release switch 42B, the image acquisition control unit 28 performs real photographing based on a photographing parameter set by the image acquisition condition setting unit 44 and the photographing method determined by the continuous shooting determination unit 46. When real photographing is performed, data of the photographed image is input to the continuous shooting buffer 52 whether one or a plurality of images are photographed. The switching unit 50 switches the input destination of the image so that in the pre-photographing, the image data is input to the image buffer 32, and in the real photographing, the image data is input to the continuous shooting buffer 52. When the image is compressed to be stored, the image data input to the continuous shooting buffer 52 is image-compressed by the compression unit 34. Meanwhile, when the image is compressed without being compressed (Bayer), the image data is not input to the compression unit 34. Thereafter, in each case, the image data is output to the memory card 38 through the memory card interface unit 36.

Next, a processing for determining the region of interest and a processing for screen-displaying the high-resolution image from step S14 to S22 will be described.

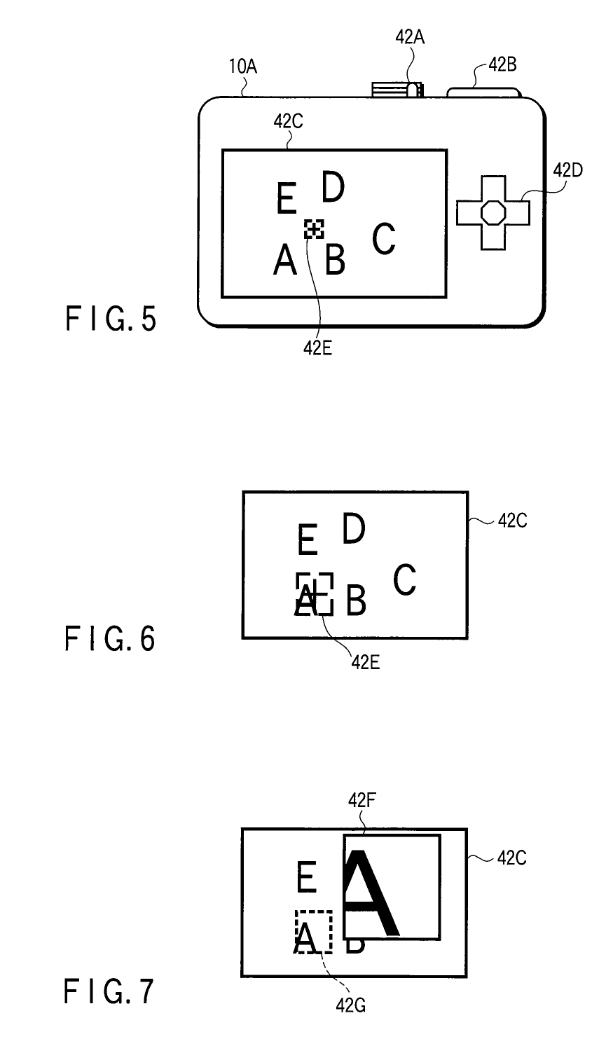

A user operates the operation button 42D of the camera body 10A to display the photographed image, stored in the memory card 38, on the liquid crystal display panel 42C through the memory card interface unit 36. At this time, as shown in FIG. 5, a region of interest designation cursor 42E is displayed on the liquid crystal display panel 42C. As shown in FIG. 6, the user operates the operation button 42D to move the region of interest designation cursor 42E, and, thus, to select the local region of a position desired to increase the resolution. In this case, the region of interest designation cursor 42E can be changed in size by operating the operation button 42D.

When the small-region automatic selection mode is not turned on, the selected local region is the region of interest. The high-resolution processing unit 54 accesses the photographed image in the memory card 38 through the memory card interface unit 36, and applies the high-resolution processing to the region of interest by using the required image data. As shown in FIG. 7, the high-resolution image is displayed on the screen of the liquid crystal display panel 42C. At this time, the high-resolution image is displayed so that the displayed part of the region of interest of the entire image with low resolution and the displayed part of the high-resolution image (high-resolution image display screen 42F) are not overlapped with each other, whereby the user can easily confirm the high resolution effect in the region of interest. Further, at that time, the displayed part of the region of interest of the entire image with low resolution is displayed as a region of interest discrimination display 42G, whereby the user can more easily compare the high-resolution image display screen 42F and the displayed part of the region of interest of the entire image with low resolution.

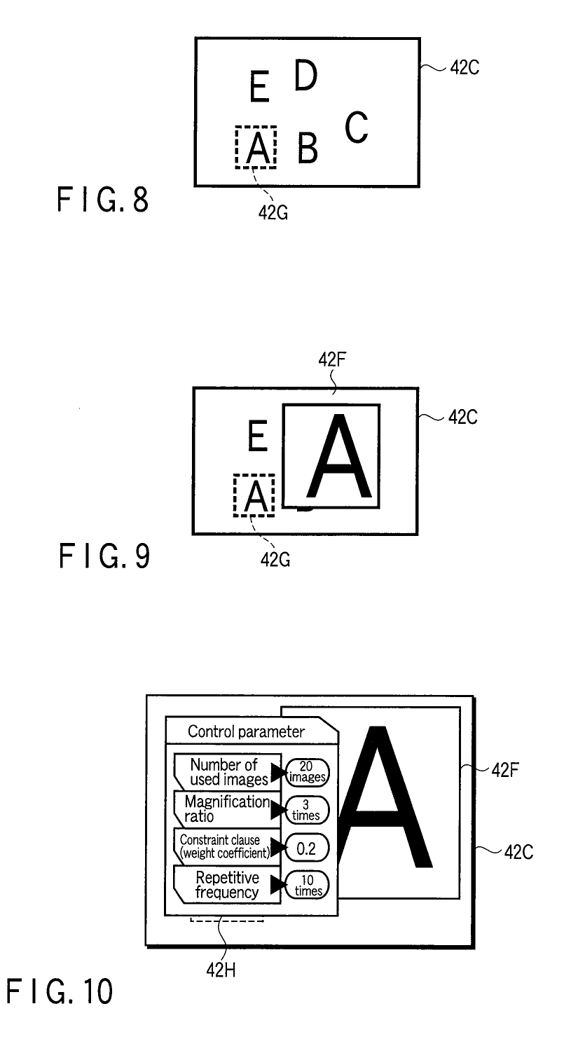

Meanwhile, when the small-region automatic selection mode is turned on, on the basis of the selected local region, a subject is detected based on color information, brightness information, and the like, and the optimum small region is determined and then to be used as the region of interest. The detection of the subject and the processing for determining a clipped region, performed by the small-region selection processing unit 56, are performed by known techniques (Jpn. Pat. Appln. KOKAI Publication Nos. 2005-078233 and 2003-256834). As shown in FIG. 8, the determined region of interest is displayed as the region of interest discrimination display 42G on the liquid crystal display panel 42C to make the user confirm the region of interest. Needless to say, it is preferable that by operating the operation button 42D, the determined region of interest can be moved or changed in size.

The high-resolution processing unit 54 then accesses the photographed image in the memory card 38 through the memory card interface unit 36, and applies the high-resolution processing to the determined region of interest by using the required image data. As shown in FIG. 9, the high-resolution image is displayed on the liquid crystal display panel 42C so that the displayed part of the region of interest of the entire image with low resolution and the displayed part of the high-resolution image (high-resolution image display screen 42F) are not overlapped with each other.

Next, an example of regulation of the control parameter used in the high-resolution processing performed in step S26 will be described. In this example, the high-resolution image of the region of interest is displayed as the high-resolution image display screen 42F on the liquid crystal display panel 42C, as shown in FIG. 9. Thereafter, the user changes the control parameter with respect to the region of interest and would again perform the high-resolution processing. In this example, the instruction is performed through the operation button 42D in step S24, whereby a control parameter setting screen 42H of FIG. 10 used for setting the control parameter is displayed on the liquid crystal display panel 42C in step S26.

The control parameter includes a number of images used in the high-resolution processing (“number of used images”), a magnification ratio of a high-resolution image (“magnification ratio”), a weight coefficient of a constraint clause of an evaluation function upon restoration of an image (“constraint clause”), and the frequency of repeated operation in the minimization of the evaluation function (“repetitive frequency”). The evaluation function and the constraint clause will be described in detail later.

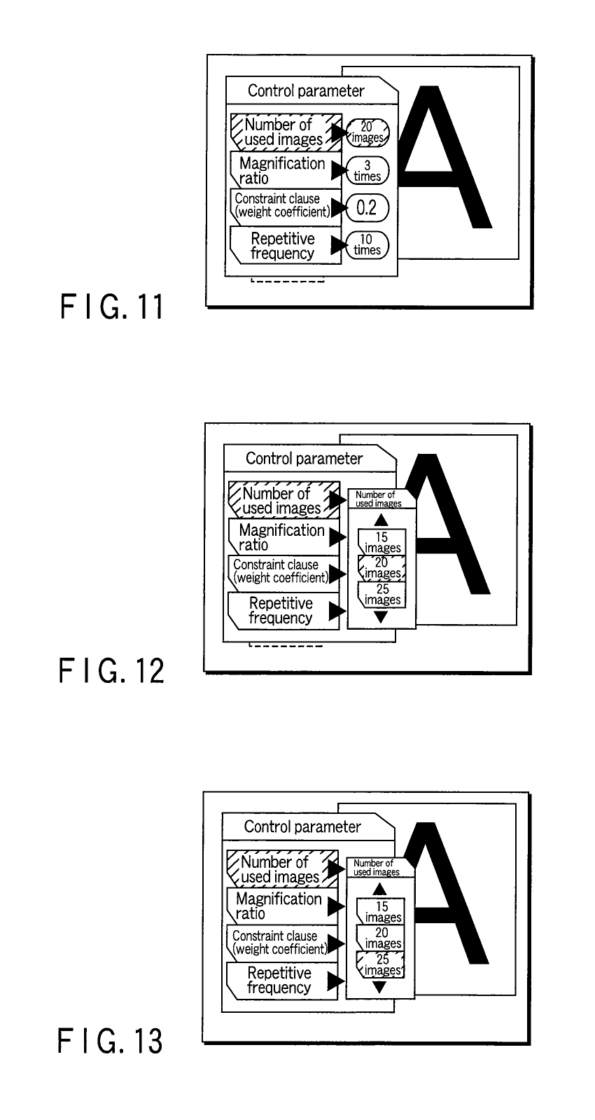

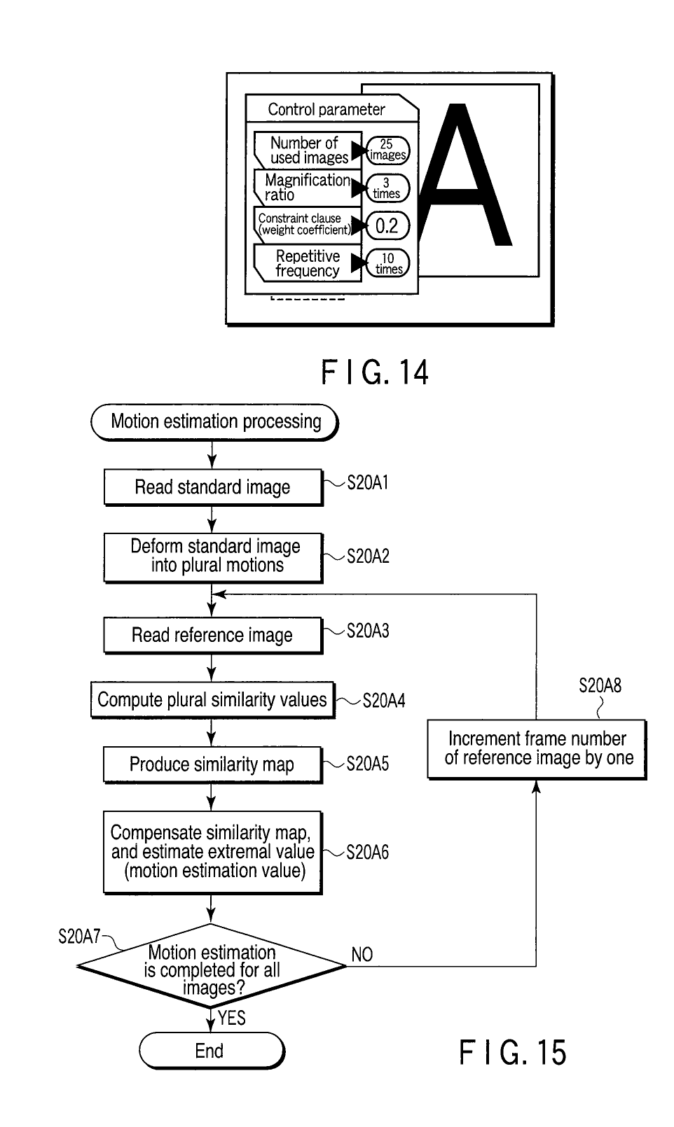

The user operates the operation button 42D to thereby select a control parameter item desired to be changed (for example, “number of used images” of FIG. 11). In FIG. 11, the selected state is represented by hatching. In response to the selection, the currently set parameter is displayed as shown in FIG. 12. Thereafter, as shown in FIG. 13, the user selects a parameter desired to be newly set. According to this constitution, as shown in FIG. 14, the control parameter is changed. The processing returns to step S20, and the high-resolution processing is performed by using the newly set control parameter. Thus, the high-resolution image is displayed again in step S22.

The high-resolution processing performed by the high-resolution processing unit 54 in step S20 includes a motion estimation processing performed by the motion estimation unit 54A and a super-resolution processing performed by the super-resolution processing unit 54B.

Regarding the image data of a plurality of images photographed in a continuous shooting mode and input to the continuous shooting buffer 52, the motion estimation unit 54A in the high-resolution processing unit 54, as shown in FIG. 15, performs the motion estimation between frames of the image data (frame) in each region of interest, using the image data in the region of interest.

The motion estimating unit 54A reads one piece of image data (standard image) in the region of interest which becomes a standard of the motion estimation (Step S20A1). The standard image may be initial image data (first frame image) in the pieces of image data of the continuously-photographed plural images, or may be image data (frame) which is arbitrarily specified by the user. Then the read standard image is deformed by plural motions (Step S20A2).

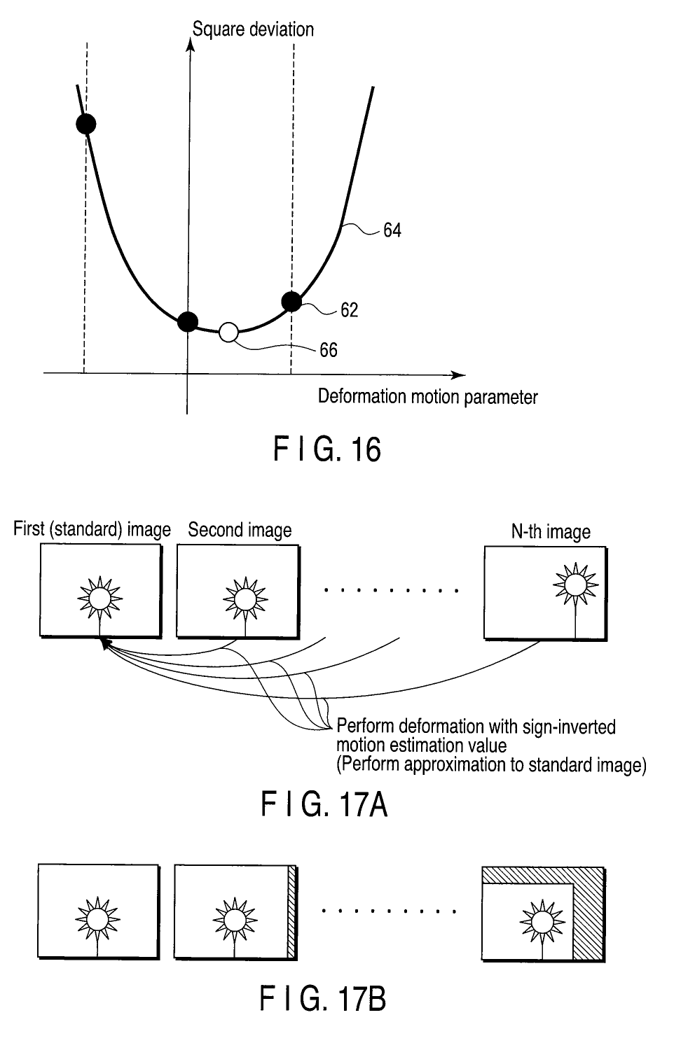

Then another piece of image data (reference image) in the region of interest is read (Step S20A3), and a similarity value is computed between the reference image and an image string in which the standard image is deformed into plural motions (Step S20A4). A discrete similarity map is produced as shown in FIG. 16 using a relationship between a parameter of the deformed motion and a computed similarity value 62 (Step S20A5), and a degree of similarity 64 which complements the produced discrete similarity map, that is, the degree of similarity 64 complemented from each computed similarity value 62 is obtained to search for an extremal value 66, thereby obtaining the extremal value (Step S20A6). The motion of the deformation having the obtained extremal value 66 becomes the estimation value. Examples of the method for searching for the extremal value 66 of the similarity map include parabola fitting and spline interpolation.

It is determined whether or not the motion estimation is performed for all the reference images (Step S20A7). When the motion estimation is not performed for all the reference images, a frame number of the reference image is incremented by one (Step S2OA8), and the flow returns to Step S20A3. Then the next reference image is read to continue the processing.

When the motion estimation is performed for all the reference images (Step S20A7), the processing is ended.

FIG. 16 is a view showing an example in which the motion estimation is performed by parabola fitting. In FIG. 16, a vertical axis indicates a square deviation, and the similarity is enhanced as the square deviation is decreased.

In the deformation in Step S20A2 of plural motions of the standard image, for example, the standard image is deformed into 19 patterns (eight patterns of 27 patterns are the same deformation pattern) by the motion parameter of ±1 pixel with respect to the horizontal, vertical, and rotation directions. At this point, a horizontal axis of the similarity map of FIG. 16 indicates a deformation motion parameter, the motion parameter of a combination of the horizontal, vertical, and rotation directions is considered by way of example, and discrete similarity values (−1,+1,−1), (−1,+1, 0), and (−1,+1,+1) are plotted from the negative side. Given an individual deformation direction, the discrete similarity values become (−1), (0), and (+1), and are separately plotted in the horizontal, vertical, and rotation directions.

The plural reference images which are continuously photographed as shown in FIG. 137 are deformed by a value in which a sign of the motion estimation value is inverted, whereby the reference images are approximated to a standard image as shown in FIG. 17B.

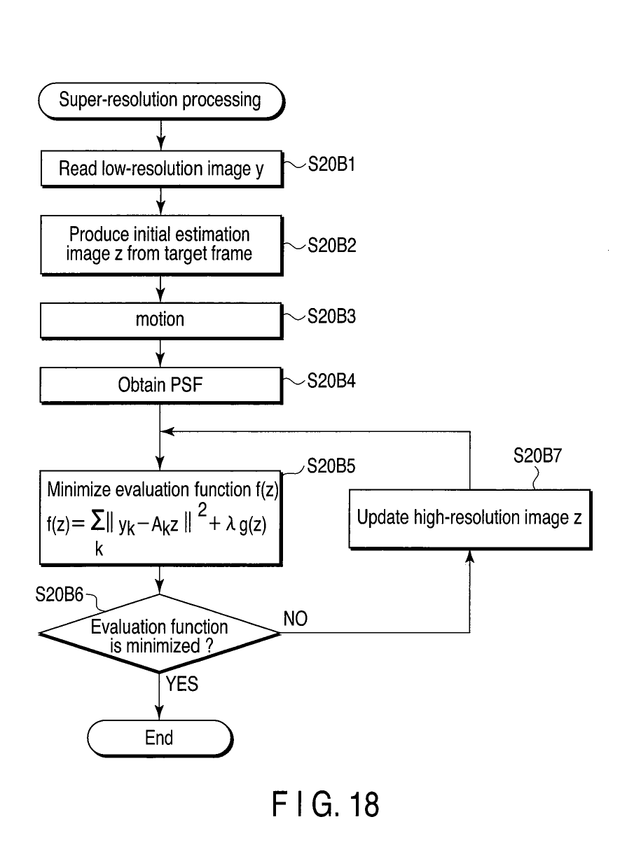

Next, an image high-resolution processing (super-resolution processing), for restoring an image with high resolution with the use of a plurality of images, performed by the super-resolution processing unit 54B of the high-resolution processing unit 54 will be described with reference to a flowchart of FIG. 18.

First, k (k≧1) image data (low-resolution image y) in the region of interest used in the high-resolution image estimation are read (step S20B1). K is set as a number of images (“number of used images”) used in the high-resolution processing using the above control parameter. Any one of the k low-resolution images y is regarded as a target frame, and an initial high-resolution image z is produced by performing interpolation processing (Step S20B2). The processing in Step S20B2 may be omitted.

A positional relationship between images is obtained by inter-frame motion (for example, as described above, the motion estimation value is obtained by the motion estimating unit 54A) between the target frame and other frames, obtained by a certain motion estimation method (Step S20B3). An optical transfer function (OTF) and a point-spread function (PSF) regarding the image acquisition characteristics such as a CCD aperture are obtained (Step S20B4). For example, a Gaussian function is used as PSF.

An evaluation function f(z) is minimized based on information on Step S20B3 and Step S20B4 (Step S20B5). At this point, the evaluation function f(z) is expressed as follows:

$$f ( z ) = {\sum }_{k}^{ } {‖ {y}_{k} - {A}_{k} z ‖}^{2} + λ g ( z )$$

where y is a low-resolution image, z is a high-resolution image, and A is an image transform matrix indicating an image acquisition system including the inter-image motion (for example, the motion estimation value obtained by the motion estimating unit 54A) and PSF (including Point-Spread Function of the electronic still camera 10, a ratio of down-sampling performed by a CCD imager 20 and a color filter array). g(z) is replaced by a restraint term regarding image smoothness and color correlation. X is a weighted coefficient. A method of steepest descent is used for the minimization of the evaluation function.

It is determined whether or not the evaluation function f(z) obtained in Step S20B5 is minimized (Step S20B6). When the evaluation function f(z) is not minimized, the high-resolution image z is updated (Step S20B7), and the flow returns to Step S20B5.

When the evaluation function f(z) obtained in Step S20B5 is minimized, because the high-resolution image z is obtained, the processing is ended.

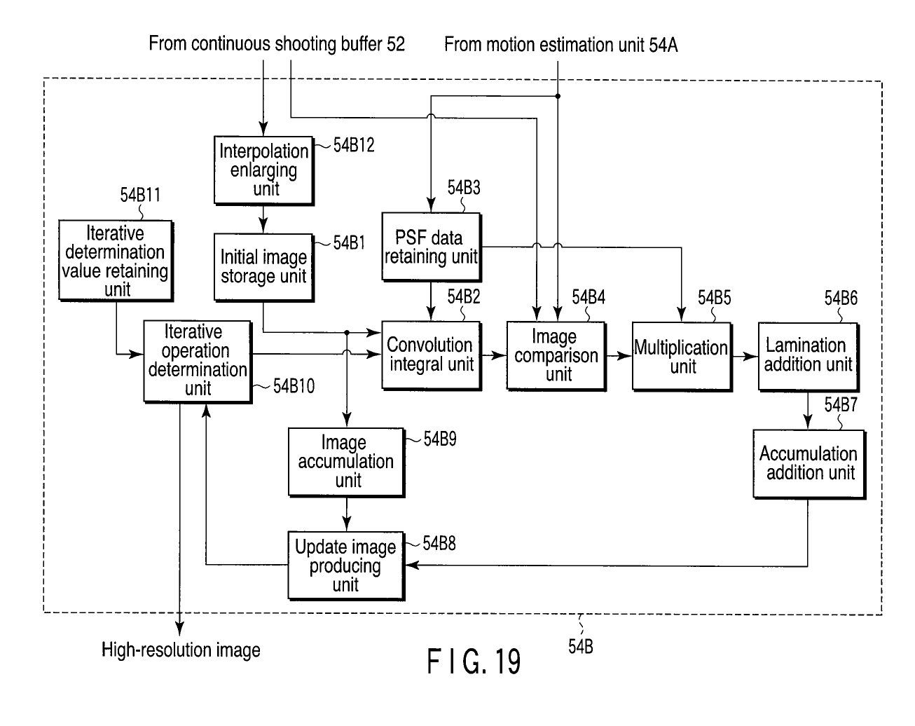

As shown in FIG. 19, the super-resolution processing unit 54B which performs the super-resolution processing includes an initial image storage unit 54B1, a convolution unit 54B2, a PSF data retaining unit 54B3, an image comparison unit 54B4, a multiplication unit 54B5, a lamination addition unit 54B6, an accumulation addition unit 54B7, an update image producing unit 54B8, an image accumulation unit 54B9, an iterative operation determination unit 54B10, an iterative determination value retaining unit 54B11, and an interpolation enlarging unit 54B12.

The interpolation enlarging unit 54B12 interpolation-enlarges the standard image supplied from the continuous shooting buffer 52, the interpolation enlarging unit 54B12 supplies the interpolation-enlarged image to the initial image storage unit 54B1, and the interpolation-enlarged image is stored as an initial image in the initial image storage unit 54B1. Examples of the interpolation method performed by the interpolation enlarging unit 54B12 include bi-linear interpolation and bi-cubic interpolation.

The initial image data stored in the initial image storage unit 54B1 is supplied to the convolution unit 54B2, which convolves the initial image data along with PSF data supplied from the PSF data retaining unit 54B3. At this point, the PSF data is supplied taking into account the motion in each frame. The initial image data stored in the initial image storage unit 54B1 is simultaneously transmitted to and stored in the image accumulation unit 54B9.

The image data convolved by the convolution unit 54B2 is transmitted to the image comparison unit 54B4. The image comparison unit 54B4 compares the convolved image data to the photographing image supplied from the continuous shooting buffer 52 at a proper coordinate position based on the motion (motion estimation value) of each frame obtained by the motion estimating unit 54A. A residual error of the comparison is transmitted to the multiplication unit 54B5, which multiplies the residual error by a value of each pixel of the PSF data supplied from the PSF data retaining unit 54B3. The operation result is transmitted to the lamination addition unit 54B6, and the values are placed at the corresponding coordinate positions. At this point, the coordinate positions of the pieces of image data supplied from the multiplication unit 54B5 are shifted step by step while overlapping each other, so that addition is performed on the overlapping portion. When the data lamination addition is completed for one photographing image, the data is transmitted to the accumulation addition unit 54B7.

The accumulation addition unit 54B7 accumulates the pieces of data sequentially transmitted until the processing is ended for the frames, and sequentially adds the pieces of image data of the frames according to the estimated motion. The added image data is transmitted to the update image producing unit 54B8. The image data accumulated in the image accumulation unit 54B9 is simultaneously supplied to the update image producing unit 54B8. The update image producing unit 54B8 weights and adds the two pieces of image data to produce update image data.

The update image data produced by the update image producing unit 54B8 is supplied to the iterative operation determination unit 54B10. The iterative operation determination unit 54B10 determines whether or not the operation is repeated based on an iterative determination value supplied from the iterative determination value retaining unit 54B11. When the operation is repeated, the data is transmitted to the convolution unit 54B2 to repeat the series of pieces of processing.

On the other hand, when the operation is not repeated, the update image data which is produced by the update image producing unit 54B8 and fed into the iterative operation determination unit 54B10 is supplied as the high-resolution image.

The resolution of the image supplied from the iterative operation determination unit 54B10 becomes higher than that of the photographing image through this series of pieces of processing.

In the convolution, because the computation at a proper coordinate position is required for the PSF data retained by the PSF data retaining unit 54B3, the motion of each frame is supplied from the motion estimating unit 54A.

As described in detail above, according to the first embodiment, before the resolution in a large region is increased by the super-resolution processing, only the local region interested by the user is screen-displayed, as a finish estimation upon increasing of the resolution, through the processing in a short time, whereby the user can easily confirm the finished condition.

Further, even when the user designates only a part of a subject to select the region of interest, a region including, for example, a character and a face is automatically extracted, whereby it is possible to assist the region selection operation by the user.

### Second Embodiment

As described in the first embodiment, when the high-resolution image in the selected region of interest is screen-displayed, the motion parameter representing the relative positional relation between frames is calculated with respect to a plurality of images. In the second embodiment, the motion information such as the motion parameter calculated in such a way is stored. When other regions of the same plurality of images are required to increase the resolution, the stored motion information is reused, whereby the improvement of the accuracy of the motion estimation processing or the speed-up of the motion estimation processing can be realized.

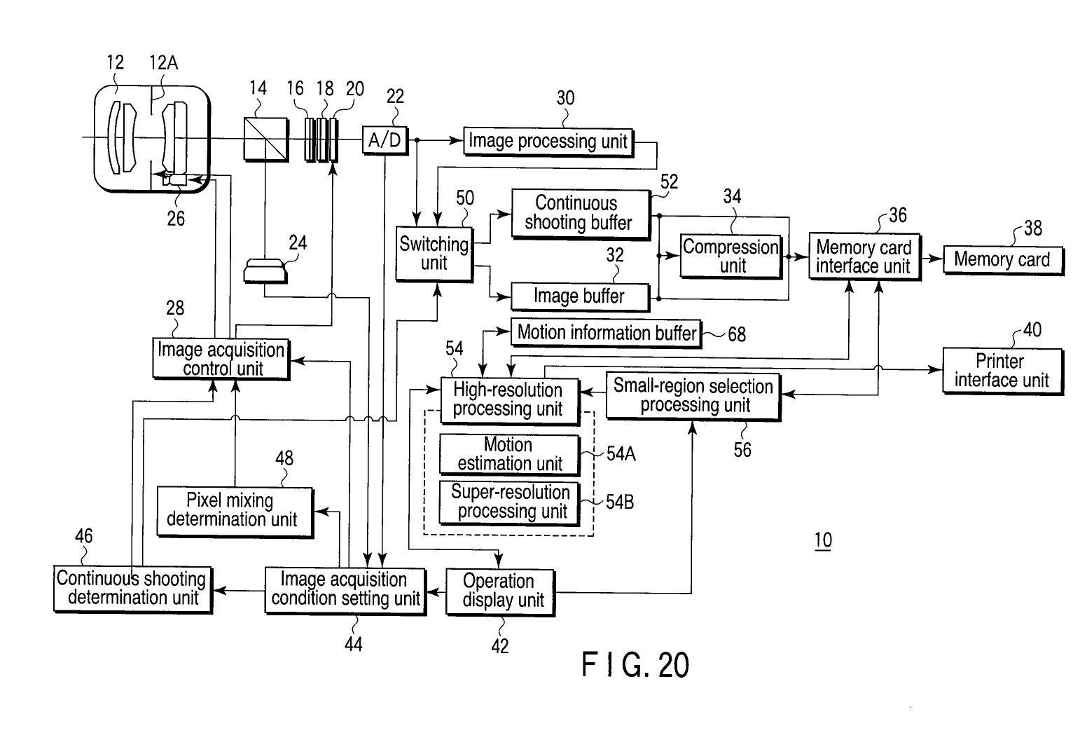

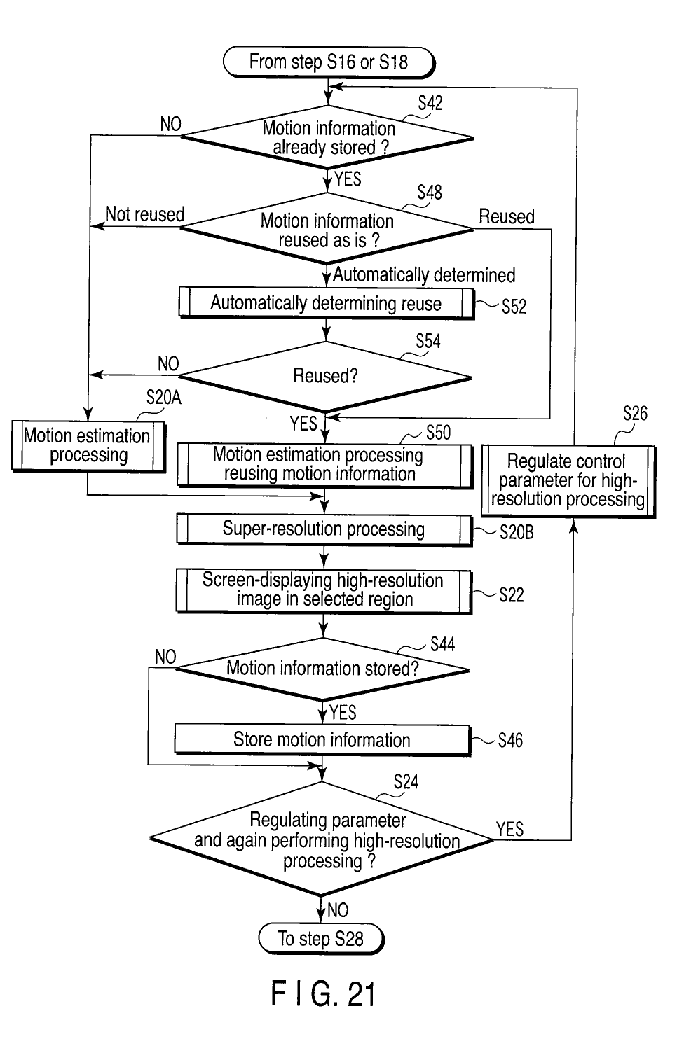

As shown in FIG. 20, the electronic still camera 10 as the second embodiment of the image processing apparatus of the invention includes a motion information buffer 68 in addition to the components in the first embodiment. The high-resolution processing unit 54 can input and output to and from the motion information buffer 68. In the second embodiment, as shown in FIG. 21, when the small-region automatic selection mode is not turned on in step S16, or after the small-region automatic selection processing in step S18, it is determined whether or not the motion information has already been stored in the motion information buffer 68 (step S42).

When the motion information is not stored yet, the high-resolution processing unit 54 applies the high-resolution processing to the selected region, using one or a plurality of images photographed in step S10. Namely, the motion estimation unit 54A performs the motion estimation processing to calculate the motion information (step S20A), and the super-resolution processing unit 54B performs the super-resolution processing, using the calculated motion information (step S20B). Thereafter, the high-resolution image in the selected region is displayed on the screen of the liquid crystal display panel 42C (step S22).

Then, whether or not the calculated motion information is stored is determined (step S44). In this case, a message asking whether or not the motion information is stored is displayed on the liquid crystal display panel 42C. In response to the message, the user operates the operation button 42D to thereby input an instruction of whether or not the motion information is stored. Alternatively, a mode of determining whether or not the motion information is stored is previously set, and the storage of the motion information may be determined according to the setting mode. When it is determined that the motion information is not stored, the processing proceeds to step S24. When it is determined that the motion information is stored, the calculated motion information of each frame is stored in the motion information buffer 68 (step S46), and the processing proceeds to step S24.

As the motion information to be stored, the similarity value computed between the standard image upon determining the motion parameter is stored in addition to the motion parameter. A sum of squared difference (SSD) or a sum of absolute difference (SAD) is used as the similarity value.

Meanwhile, when it is determined that the motion information has already been stored in the motion information buffer 68 in step S42, it is further determined whether or not the stored motion information is reused as it is (step S48). In this case, the user operates the operation button 42D to thereby input the instruction of determining whether or not the stored motion information is reused as it is.

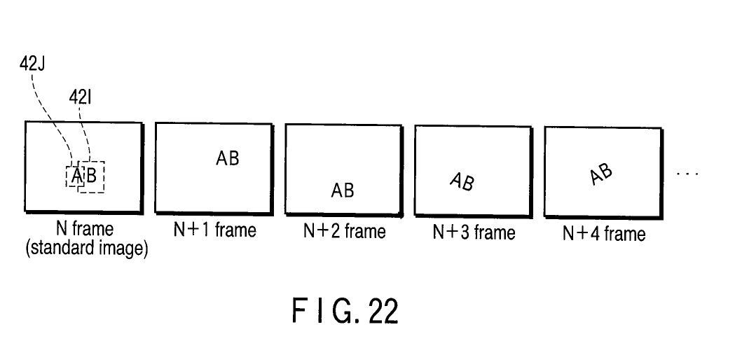

The case where the user determines that the motion information is reused as it is in step S48 is shown in, for example, FIG. 22. That is, this case is such a case that it can be determined that the motion between the subject included in a presently selected region 42I and the subject in another frame is the same as the motion between a subject included in a previously selected region 42J in the standard image selected in the display of the high-resolution image and the subject in another frame. This case includes the situation where when a motionless subject or a subject with less motion is continuously photographed, hand shake of the photographer occurs.

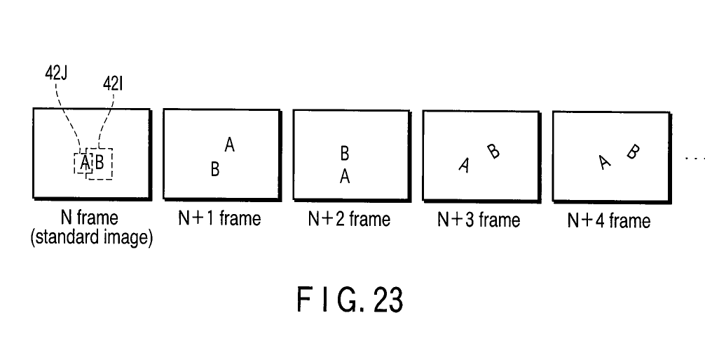

The case where the user determines that the motion information is not reused is shown in, for example, FIG. 23. That is, this case is such a case that it can be determined that the motion between the subject included in the presently selected region 42I and the subject in another frame is different from the motion between a subject included in the previously selected region 42J and the subject in another frame. This case includes the situation where two subjects with different motions in a field angle are continuously photographed.

When it is determined that the motion information is not reused in step S48, the processing proceeds to step S20A. The motion estimation processing is newly performed in step S20A, and thereafter, the super-resolution processing is performed in step S20B. When it is determined that the motion information is reused as it is, the motion estimation processing reusing the motion information is performed (step S50), the detail of which will be described later. The super-resolution processing is performed in step S20B, using the motion information obtained by the motion estimation processing in step S50.

In this embodiment, the reuse of the motion information can be automatically determined. When it is determined that the user instructs automatic determination of whether or not the motion information is reused in step S48, a motion information reuse automatic determination processing, to be described in detail later, is performed (step S52), whereby whether or not the motion information is reused is determined (step S54). When it is determined that all frames of the motion information are not reused, the processing proceeds to step S20A, and thus the motion estimation processing is newly performed. Meanwhile, when it is determined that at least one frame of the motion information is reused, the processing proceeds to step S50, and thus the motion estimation processing reusing the motion information is performed. The super-resolution processing of step S20B is then performed by using the motion information obtained by the newly performed motion estimation processing or the motion information obtained by the motion estimation processing reusing the motion information.

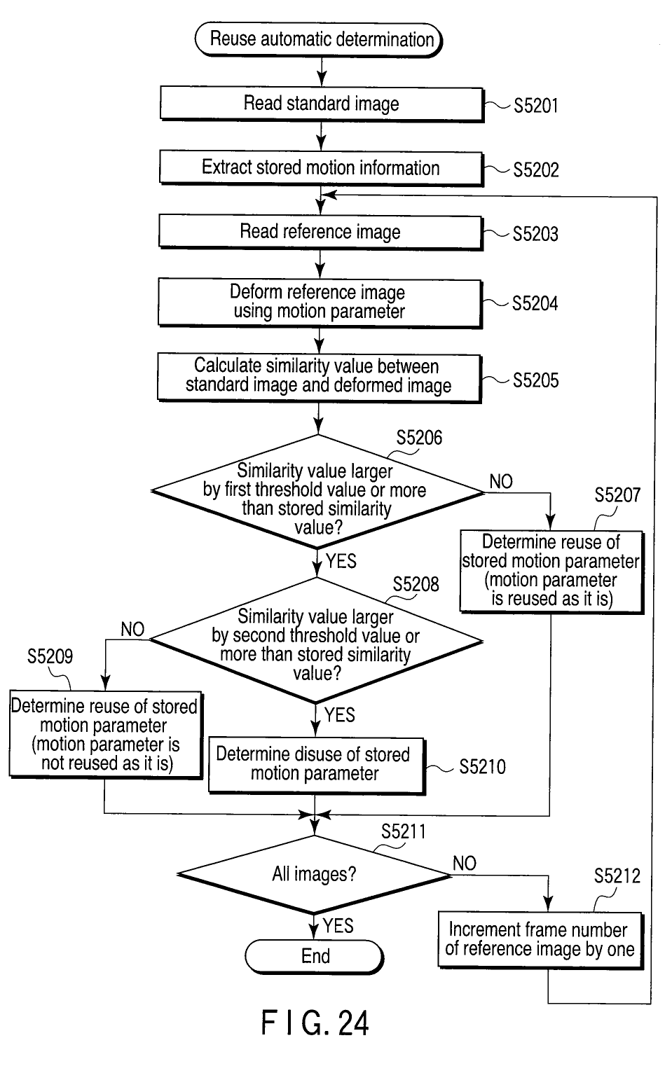

In the motion information reuse automatic determination processing of step S52, as shown in FIG. 24, the standard image is first read (step S5201). The motion parameter of each frame as the motion information and the information of the similarity value with respect to the standard image, which are stored in the motion information buffer 68, are extracted (step S5202). Further, the reference image in a target frame is read (step S5203), and then deformed using the extracted motion parameter (step S5204). The similarity value between the standard image and the deformed image is calculated (step S5205). Thereafter, it is determined whether or not the calculated similarity value is larger by a first threshold value or more than the stored similarity value extracted in step S5205 (step S5026).

When it is determined that the calculated similarity value is less than the first threshold value, that is, when the calculated similarity value is close to the stored similarity value, the motion of the subject estimated in the previous high-resolution processing is similar to the motion of the subject which will be obtained in the present high-resolution processing. Thus, in this case, it is determined that the motion parameter stored in the motion information buffer 68 is reused as it is (step S5207).

Meanwhile, when it is determined that the calculated similarity value is larger by the first threshold value or more than the stored similarity value in step S5206, it is further determined whether or not the similarity value calculated in step S5205 is larger by a second threshold value or more (the second threshold value > the first threshold value) than the stored similarity value extracted in step S5202 (step S5028). When it is determined that the calculated similarity value is the first threshold value or more and less than the second threshold value, the motion of the subject estimated in the previous high-resolution processing is substantially the same as the motion of the subject which will be obtained in the present high-resolution processing. Thus, in this case, it is determined that the stored motion parameter is reused; however, the motion parameter is not reused as it is (step S5209).

When it is determined that the similarity value is larger by the second threshold value or more than the similarity value in step S5208, the motion of the subject estimated in the previous high-resolution processing is completely different from the motion of the subject which will be obtained in the present high-resolution processing. Thus, in this case, it is determined that the stored motion parameter is not reused (step S5210).

After steps S5027, S5209 and S5210, it is determined whether or not the processing is applied to all the reference images (step S5211). When there is a frame of the unprocessed reference image, a frame number of the reference image is incremented by one (step S5212), and the processing returns to step S5203.

As described above, the automatic determination processing is applied to all the reference images for each one frame of the reference image used in the high-resolution processing.

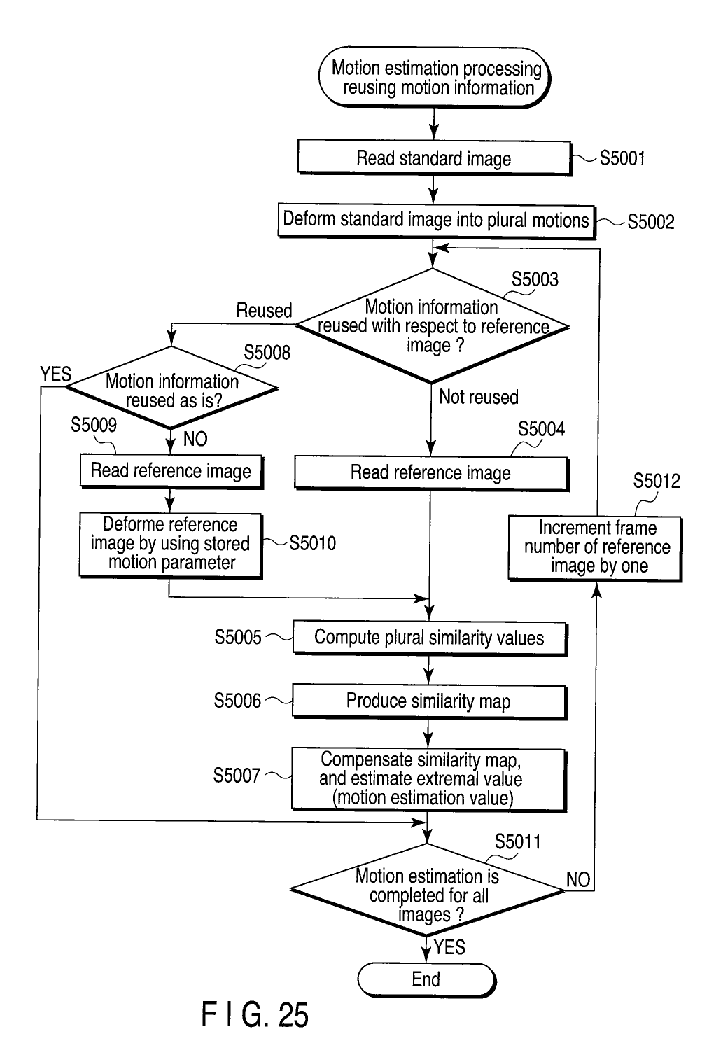

In the motion estimation processing reusing the motion information of step S50, as shown in FIG. 25, the standard image is read (step S5001) to be deformed into plural motions (step S5002). Then, it is determined whether or not the motion information is reused with respect to the frame of the reference image to be processed (step S5003).

When it is determined that the motion information is not reused, that is, when it is determined that in step S5210 the motion information is not reused with respect to the relevant frame, the reference image of the frame is read (step S5004). The calculation of each similarity value (step S5005), the production of the similarity map (step S5006), and the estimation of the extremal value of the complementary similarity map (calculation of a motion estimation value) (step S5007) are sequentially performed.

Meanwhile, when it is determined that the motion information is reused in step S5003, it is further determined whether or not the motion parameter is reused as it is (step S5004). When it is determined that the motion parameter is not reused as it is, that is, when it is determined that in step S5209, with respect to the relevant frame, the motion parameter stored in the motion information buffer 68 is not reused as it is, but reused, the reference image in the frame is read (step S5009). The read reference image is deformed with the motion parameter stored in the motion information buffer 68 (step S5010). Thereafter, each similarity value is calculated in step S5005, the similarity map is produced in step S5006, and the extremal value of the complementary similarity map is estimated in step S5007. The motion estimation value is calculated thus, whereby the calculation of the similarity value is omitted for a large motion. Accordingly, the calculation time can be reduced, and, at the same time, the accuracy of the calculation of the motion estimation can be improved.

When it is determined that the motion information is reused as it is in step S5008, that is, when it is determined that in step S5207 the motion parameter stored in the motion information buffer 68 is reused as it is with respect to the relevant frame, the stored motion parameter is used as it is, and therefore, the motion estimation value is not newly calculated.

After step S5007, or when it is determined that the motion information is reused as it is in step S5208, it is determined whether or not the processing is applied to all the reference images used in the increasing of the resolution (step S5011). When there is a frame of the unprocessed reference image, a frame number of the reference image is incremented by one (step S5012), and the processing returns to step S5003.

As described above, the motion estimation processing is applied to all the reference images for each one frame of the reference image used in the increasing of the resolution.

Note that the standard image reading processing of step S5001 is similar to the processing of step S20A1 of FIG. 15. The processing for deforming the reference image into plural motions of step S5002 is similar to the processing of step S20A2 of FIG. 15. The reference image reading processing of step S5004 is similar to the processing of step S20A3 of FIG. 15. The similarity value calculation processing of step S5005 is similar to the processing of step S20A4 of FIG. 15. The similarity map production processing of step S5006 is similar to the processing of step S20A5 of FIG. 15. The processing for estimating the extremal value of the complementary similarity map is similar to the processing of step S20A6 of FIG. 15.

As described above, according to the second embodiment, the motion information estimated by the calculation in the finish estimation display is reused, whereby the calculation time of the motion estimation processing in a large region is reduced thus to allow the user waiting time to be reduced, and, at the same time, the accuracy of the motion compensation can be improved.

### Third Embodiment

In the first and second embodiments, all the functions of an image processing apparatus are provided in the electronic still camera 10; however, other functions may be provided in the electronic still camera 10.

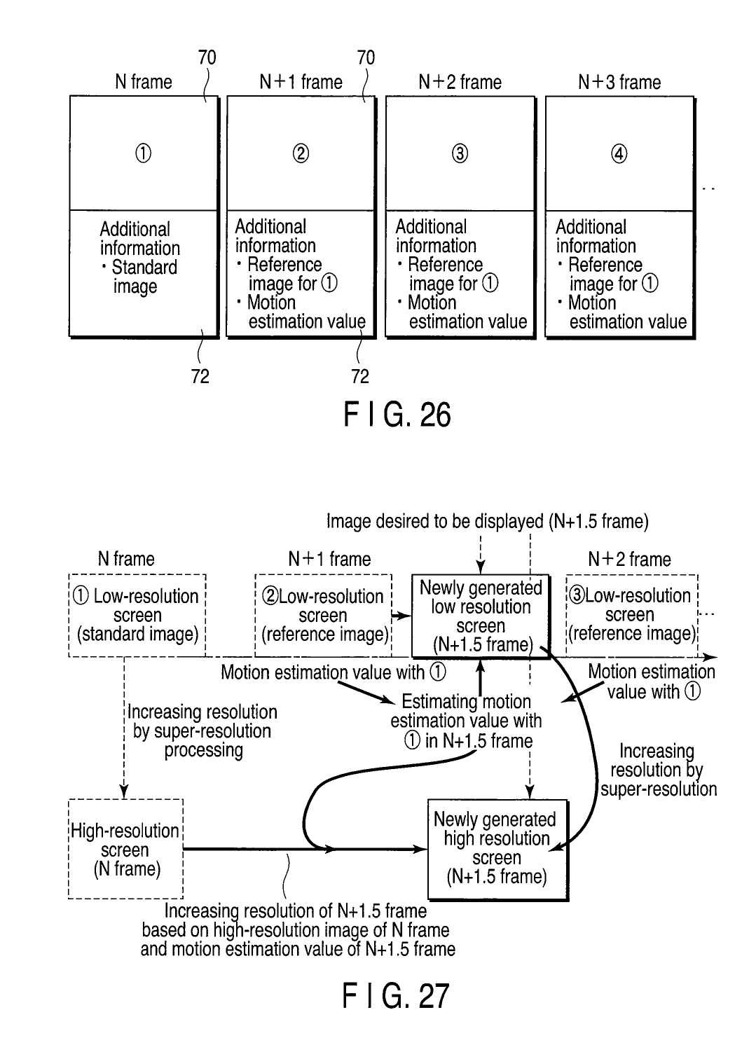

For example, the super-resolution processing unit 54B can be realized by other hardware and software. In this case, the motion estimation value is calculated between plural images by the motion estimation processing performed by the motion estimation unit 54A. The motion estimation value as additional information is added to each image. The images having the additional information are recorded in the memory card 38 via the memory card interface unit 36. The images recorded in the memory card 38 are input to the super-resolution processing unit 54B constituted of other hardware or software. As shown in FIG. 26, the additional information is used to discriminate between the standard image and the reference image and adds the motion estimation value, which is an amount of deviation from the standard image, to the reference image.

The additional information 72 is given to each image 70, whereby when the super-resolution processing is performed, the resolution can be increased based on the additional information. Accordingly, the super-resolution processing can be realized by other hardware or software.

In the above case, for example, N+15 frame which is the reference image can be changed into the standard image. In this case, the calculation is performed based on the motion estimation value included in the additional information 72 of each of the images 70, whereby a motion value between a newly set standard image and the reference image other than the standard image can be easily obtained.

### Fourth Embodiment

A user wants to display an image in N+α+βframe (α=an integer value within a predetermined time, 0<β<1), and when, for example, α=1 and β=0.5, the high-resolution processing unit 54, as shown in FIG. 27, estimates the motion estimation value of N+1.5 frame based on the motion estimation value from the standard image of the image in N+1 frame and the image in N+2 frame and generates a low-resolution image (display original image) or the high-resolution image in N+1.5 frame.

When the high-resolution image in N+α+β frame is generated, a low-resolution image in N+α+β frame is temporarily generated. The resolution of the generated low-resolution image is increased by the super-resolution processing, using low-resolution images before and after the low-resolution image in N+α+β frame which is the standard image. The high- resolution image in N+α+β frame can be generated based on a super-resolution image in N frame generated on the basis of N frame as the standard image.

Thus, the invention has been described above based on the embodiments. The invention is not limited to the embodiments, and obviously various modifications and applications can be made without departing from the scope of the invention.

For example, a software program for realizing the functions of the embodiments is supplied to a computer, and the computer executes the program using the low-resolution image stored in the memory, which allows the functions to be realized.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An image processing apparatus comprising:
a high-resolution processing unit configured to restore, with respect to an image desired to be displayed, a frequency band higher than a frequency band of the recorded image, using one of one electronically recorded image and a plurality of electronically recorded images obtained by continuous shooting;
a local region designation unit configured to designate a region of the image desired to be displayed where the resolution is increased; and
an estimation display unit configured to display, as a finish estimation image after high-resolution processing is applied to the image desired to be displayed, the result of the high-resolution processing applied to a local region, designated by the local region designation unit, by the high-resolution processing unit.

2. The image processing apparatus according to claim 1, wherein the estimation display unit displays a high-resolution image of the local region, designated by the local region designation unit, within a frame separately provided on a screen.

3. The image processing apparatus according to claim 1, wherein the estimation display unit displays a high-resolution image of a local region, designated by the local region designation unit, so that the high-resolution image is not overlapped with the local region designated by the local region designation unit.

4. The image processing apparatus according to claim 1, wherein the high-resolution processing unit includes:
a motion compensation unit configured to estimate a motion of a subject between a plurality of the electronically recorded images, using one of one image and a plurality of images in a local region designated by the local region designation unit, to thereby compensate a relative positional relation between the plurality of images; and
an image composition unit configured to generate an image obtained by composing the plurality of images compensated by the motion compensation unit.

5. The image processing apparatus according to claim 4, wherein the motion compensation unit stores, in a storage unit, motion information in which the motion of the subject in the local region, designated by the local region designation unit, is estimated.

6. The image processing apparatus according to claim 5, wherein after the finish estimation image after the high-resolution processing is displayed by the estimation display unit, when the local region is designated again by the local region designation unit and the high-resolution processing is applied to the local region by the high-resolution processing unit, the motion compensation unit reuses the motion information stored in the storage unit.

7. The image processing apparatus according to claim 1, further comprising a storage unit configured to store, in individual electronic files, a high-resolution image in the local region designated by the local region designation unit.

8. The image processing apparatus according to claim 1, further comprising an output unit configured to, in order to print the individual high-resolution images in the local region designated by the local region designation unit, output the high-resolution images to printing unit.

9. The image processing apparatus according to claim 1, wherein the high-resolution processing unit includes:
a motion estimation unit configured to estimate a motion of a subject between a plurality of the electronically recorded images, using one of one image and a plurality of images in a peripheral region including the local region designated by the local region designation unit; and
an additional information recording unit configured to add additional information, which indicates that an image is a standard image, to a standard image of a plurality of the electronically recorded images used in the estimation of the motion of the subject, to add, to each of the remaining images, additional information, which includes information, indicating that an image is a reference image with respect to the standard image, and each of the motion estimation values estimated by the motion estimation unit, and to record the images with the additional information.

10. The image processing apparatus according to claim 9, wherein the high-resolution processing unit further includes:
a motion compensation unit configured to compensate a relative positional relation between the plurality of images on the basis of each of the additional information of the plurality of images recorded by the addition information recording unit, using one of one image and a plurality of images in a peripheral region including the local region designated by the local region designation unit; and
an image composition unit configured to generate an image obtained by composing the plurality of images compensated by the motion compensation unit.

11. An image processing apparatus comprising:
a high-resolution processing unit configured to restore, with respect to an image desired to be displayed, a frequency band higher than a frequency band of the recorded image, using one of one electronically recorded image and a plurality of electronically recorded images obtained by continuous shooting;
a local region designation unit configured to designate a region of the image desired to be displayed where the resolution is increased;
a small-region selection unit configured to select a small region included in a local region designated by the local region designation unit; and
an estimation display unit configured to display, as a finish estimation image after high-resolution processing is applied to the image desired to be displayed, the result that the high-resolution processing unit applies the high-resolution processing to a small region of the image selected by the small-region selection unit.

12. The image processing apparatus according to claim 11, wherein the small-region selection unit analyzes the homology of color information, brightness information, a texture, and components between the electronically recorded images and to automatically select the small region based on the analysis result.

13. The image processing apparatus according to claim 12, wherein the small region determined by the small-region selection unit includes a part of the local region designated by the local region designation unit.

14. The image processing apparatus according to claim 11, wherein the estimation display unit displays a high-resolution image in the small region, selected by the small-region selection unit, within a frame separately provided on a screen.

15. The image processing apparatus according to claim 11, wherein the estimation display unit displays on a screen a high-resolution image in the small region, selected by the small-region selection unit, so that the high-resolution image is not overlapped with the small region selected by the small-region selection unit.

16. The image processing apparatus according to claim 11, wherein the high-resolution processing unit includes:
a motion compensation unit configured to estimate a motion of a subject between a plurality of the electronically recorded images, using one of one image and a plurality of images in a peripheral region including the small region selected by the small-region selection unit, to thereby compensate a relative positional relation between the plurality of images; and
an image composition unit configured to generate an image obtained by composing the plurality of images compensated by the motion compensation unit.

17. The image processing apparatus according to claim 16, wherein the motion compensation unit stores, in s storage unit, motion information in which the motion of the subject in the small region, selected by the small-region selection unit, is estimated.

18. The image processing apparatus according to claim 17, wherein after the finish estimation image after the high-resolution processing is displayed by the estimation display unit, when the small region is selected again by the small-region selection unit and the high-resolution processing is applied to the small region by the high-resolution processing unit, the motion compensation unit reuses the motion information stored in the storage unit.

19. The image processing apparatus according to claim 11, further comprising a storage unit configured to store, in individual electronic files, a high-resolution image in the small region selected by the small-region selection unit.

20. The image processing apparatus according to claim 11, further comprising an output unit configured to, in order to print the individual high-resolution images in the small region selected by the small-region selection unit, output the high-resolution images to printing unit.

21. The image processing apparatus according to claim 11, wherein the high-resolution processing unit includes:
a motion estimation unit configured to estimate the motion of the subject between a plurality of the electronically recorded images, using one of one image and a plurality of images in a peripheral region including the small region selected by the small-region selection unit; and
an additional information recording unit configured to add additional information, which indicates that an image is a standard image, to a standard image of a plurality of the electronically recorded images used in the estimation of the motion of the subject, to add, to each of the remaining images, additional information, which includes information, indicating that an image is a reference image with respect to the standard image, and each of the motion estimation values estimated by the motion estimation unit, and to record the images with the additional information.

22. The image processing apparatus according to claim 21, wherein the high-resolution processing unit further includes:
a motion compensation unit configured to compensate a relative positional relation between the plurality of images on the basis of each of the additional information of the plurality of images recorded by the additional information recording unit, using one of one image and a plurality of images in the peripheral region including the small region selected by the small-region selection unit; and
an image composition unit configured to generate an image obtained by composing the plurality of images compensated by the motion compensation unit.

23. The image processing apparatus according to claim 11, further comprising a display original image generation unit configured to, when the image desired to be displayed corresponds to a position between any two images of a plurality of the electronically recorded images continued within a time satisfying a predetermined condition, generate a new display original image before the high-resolution processing from one of one image and a plurality of the continuous recorded images positioned near the image desired to be displayed.

24. The image processing apparatus according to claim 23, wherein the display original image generation unit includes a motion compensation unit configured to estimate the motion of a subject positioned at the image desired to be displayed, using one of one image and a plurality of the recorded images positioned near the image desired to be displayed, to thereby compensate a relative positional relation between one of one image and a plurality of the images used by the high-resolution processing unit.

25. The image processing apparatus according to claim 4, wherein when the image desired to be displayed corresponds to a position between any two images of a plurality of the electronically recorded images continued within a time satisfying a predetermined condition, the high-resolution processing unit estimates the motion of the subject positioned at the image desired to be displayed, using one of one image and a plurality of images positioned near the image desired to be displayed, to thereby compensate the relative positional relation between one of one image and a plurality of the images used by the high-resolution processing unit.

26. The image processing apparatus according to claim 4, wherein the motion compensation unit adds additional information, which indicates that an image is a standard image, to a standard image of a plurality of the recorded images used in the estimation of the motion of the subject and adds, to each of the remaining images, additional information, which includes information, indicating that an image is a reference image with respect to the standard image, and each of the estimated motion estimation value, and records the images with the additional information.

27. The image processing apparatus according to claim 1, wherein the estimation display unit includes a parameter regulation unit configured to regulate a control parameter for the high-resolution processing performed by the high-resolution processing unit.

28. The image processing apparatus according to claim 27, wherein the control parameter includes at least one of a number of images, an image magnification ratio, a weight coefficient of a constraint clause of an evaluation function upon restoration of an image, and a frequency of repeated operation in the minimization of the evaluation function, which are used in the high-resolution processing performed by the high-resolution processing unit.

29. An image processing program making a computer execute:
restoring, with respect to an image desired to be displayed, a frequency band higher than a frequency band of the recorded image, using one of one electronically recorded image and a plurality of electronically recorded images obtained by continuous shooting;
designating a region of the image desired to be displayed where the resolution is increased; and
displaying, as a finish estimation image after high-resolution processing is applied to the image desired to be displayed, the result of the high-resolution processing applied to the designated local region of the image desired to be displayed.

30. An image processing program making a computer execute:
restoring, with respect to an image desired to be displayed, a frequency band higher than a frequency band of the recorded image, using one of one electronically recorded image and a plurality of electronically recorded images obtained by continuous shooting;
designating a region of the image desired to be displayed where the resolution is increased;
selecting a small region included in the designated local region; and
displaying, as a finish estimation image after high-resolution processing is applied to the image desired to be displayed, the result of the high-resolution processing applied to the selected small region of the image desired to be displayed.

31. An image production method comprising:
confirming a finish estimation image of a desired image by using the image processing apparatus according to claim 1; and
generating an image having a frequency band larger than a frequency band of the desired image with respect to the confirmed desired image to produce an image medium.

32. A computer-readable recording medium recording an image including:
additional information which includes information, which indicates whether the image of a plurality of electronically recorded images, used in the estimation of a motion of a subject, is a standard image or a reference image with respect to the standard image; and
a motion estimation value which, when the image is the reference image, is estimated based on the standard image.
